(19) United States
(12) Patent Application Publication
(10) Pub. No.: US 2010/0103582 A1
(43) Pub. Date: Apr. 29, 2010

(54) LIGHTING PROTECTION SYSTEM FOR GRAPHITE FIBER REINFORCED PLASTIC STRUCTURES

(76) Inventors: Harry B. Shimp, Chagrin, OH (US); Kenneth Mull, Woodbridge, CT (US); Kirt Griffin, Guildford, CT (US)

Correspondence Address: Ballard Spahr LLP, SUITE 1000, 999 PEACHTREE STREET, ATLANTA, GA, 30309-3915, US

(21) Appl. No.: 12/259,880

(22) Filed: Oct. 28, 2008

(51) Int. Cl. H02G 13/00

(52) U.S. Cl. 361/220; 174/2; 361/218

(57) ABSTRACT

The present disclosure provides a lightning protection system and a composite structure comprising such a lightning protection system, wherein the lightning protection system comprises a metal foil layer, a plastic layer, and a matrix material.

### BACKGROUND OF THE INVENTION

1. Field of the Invention

The present invention relates to lightning protection systems and materials used therein.

2. Technical Background

Lightning protection is a requirement for aircraft and aerospace structures to ensure safe flight and prevent damage to aircraft components. Lightning discharges to or from an aircraft, if not quickly dispersed, can cause serious damage to aerospace components, such as, for example, delamination and/or embrittlement, and can cause electrical interference with, for example, avionics systems. Typical lightning strikes can result in localized temperatures of about 20,000° C. or higher and electrical currents of 250,000 amperes or more. During flight, aircraft can often trigger lightning, such as, for example, when flying into a heavily charged area of a cloud.

Many aerospace structures are made of aluminum. The relatively high electrical conductivity of such aluminum structures ensures that the energy from a lightning strike can remain on and be dissipated across the aircraft's exterior surface. Other aerospace structures can be comprised of composite materials, such as, for example, fiber reinforced polymer (FRP) materials.

Lightning protection systems are of particular concern for such composite aerospace structures. Composite materials are typically less conductive than their aluminum counterparts and thus, less able to dissipate the energy resulting from a lightning strike.

The traditional engineering approach to protecting FRP structures from lightning has been to include a thin layer of metal foil or screen in the outer layer of the composite. When struck by lightning, the metal can be instantly vaporized into a plasma ball that very rapidly disperses the energy, sacrificially protecting the FRP structure underneath. The metal may be solid foil, expanded foil, woven wire screen, or wire interwoven into the fiber matrix.

The metals used in a traditional lightning protection system can be selected for their ability to absorb energy (heat of vaporization), electrical conductivity, and inertness relative to the graphite fibers in the FTP. Most lightning protection systems utilize aluminum or copper containing components. Aluminum has a high capacity to absorb energy and is an excellent conductor per unit of weight, but has a high electrochemical potential with graphite. In contrast, copper and its alloys are not as capable as aluminum in absorbing energy per unit weight, but have a low reaction potential with graphite.

In order to make effective use of aluminum, a metal layer is typically insulated from the reinforcing graphite structure in the composite by a physical barrier layer. Corrosion, resulting from an electrochemical reaction, can occur if the metal layer and the graphite structure come in contact with another. Thus, the current understanding, prior to this invention, is that such a barrier layer must be an electrical insulator. The traditional approach to preventing such contact between the metal layer and the graphite component is to separate the metal and graphite with a thin mat of woven glass fiber. The perceived advantage of such a woven glass mat is that it can become wetted and infused with the polymeric resin of the composite structure, thus creating a solid composite material.

There is a need to address the aforementioned problems and other shortcomings associated with traditional lightning protection systems. These needs and other needs are satisfied by the expanded metal technology of the present invention.

### SUMMARY OF THE INVENTION

The present invention relates to lightning protection systems, and specifically to lightning protection systems comprising an expanded metal component and suitable for use in a fiber reinforced polymer structure

In a first aspect, the present invention provides a lightning protection system comprising a plastic layer, a metal foil layer positioned in at least partial overlying registration therewith, and a matrix material in at least partial contact with both the plastic layer and the metal foil layer.

In a second aspect, the present invention provides a composite structure comprising a graphite component and the lightning protection system described above, wherein the metal foil layer and the graphite component are not in direct contact.

Additional aspects and advantages of the invention will be set forth, in part, in the detailed description, figures, and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain aspects of the present invention and together with the description, serve to explain, without limitation, the principles of the invention. Like numbers represent the same elements throughout the figures.

FIG. 1 is a schematic illustration of an exemplary lightning protection structure, in accordance with the various aspects of the present disclosure.

### DETAILED DESCRIPTION OF THE INVENTION

The present invention can be understood more readily by reference to the following detailed description, drawings, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its currently known embodiments. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “component” includes aspects having two or more such components, unless the context clearly indicates otherwise.

“Optional” or “optionally” means that the subsequently described event or circumstance can or cannot occur, and that the description includes instances where the event or circumstance occurs and instances where it does not. For example, the phrase “optionally substituted component” means that the component can or can not be substituted and that the description includes both unsubstituted and substituted aspects of the invention.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

As used herein, the term “fiber reinforced,” unless specifically stated to the contrary, refers to a structure or an article reinforced with another material, such as, for example, fiber, carbon, fiberglass, Kevlar. Other reinforcing materials are also intended to be included and the level and/or concentration of reinforcing material can vary. Other similar and/or related structures that are not reinforced, but that could be reinforced, are also intended to be included in the various aspects described herein.

As briefly introduced above, the present invention provides a lightning protection system comprising a plastic layer, a metal foil layer, and a matrix material.

### Plastic Layer

The plastic layer of the present disclosure can comprise any plastic material suitable for use in a lightning protection system, a fiber reinforced polymer composite, or a combination thereof.

In one aspect, the plastic layer can comprise one or more polymeric materials chemically compatible with any other components that can be present, such as, for example, a metal foil layer, a graphite or carbon fiber reinforcing component, a matrix material, or a combination thereof.

In various aspects, the plastic layer can comprise a polyolefin, such as, for example, polyethylene and/or polypropylene, a polyester, such as, for example, polycarbonate, polyethylene terephthalate, polybutyrate, or a combination thereof. In other aspects, the plastic layer can comprise a fluoropolymer, a thermoplastic, or a combination thereof. In still other aspects, the plastic layer can comprise a polyurethane, a polysulfone, an acrylonitrile butadiene styrene, a polyetheretherketone, a polyaryletherketone, or a combination thereof. In yet other aspects, the plastic layer can comprise any one or more polymeric materials and the present disclosure is not intended to be limited to any particular recited polymeric material or combination of polymeric materials.

In one aspect, the plastic layer can comprise a single polymeric material. In another aspect, the plastic layer can comprise a mixture of any two or more individual plastic materials. In another aspect, the plastic layer can comprise a copolymer of any two or more individual monomer materials. In yet another aspect, the plastic layer can comprise a blend of any two of more polymeric materials.

In another aspect, the plastic layer can comprise two or more discrete polymeric materials in separate layers, for example, positioned in at least partial overlying registration to another.

The plastic layer of the present disclosure can have any dimensions and physical form suitable for use in a lightning protection system, a fiber reinforced polymer composite, or a combination thereof. In one aspect, the plastic layer comprises a sheet good having dimensions suitable for use in an aerospace component, such as, for example, a fiber reinforced composite structure. It should be understood that the length, width, and thickness of a plastic layer or any portion thereof can vary depending upon, for example, the intended application, the composition and physical properties (e.g., viscosity) of a matrix material, and/or the desired physical strength of a resulting composite structure.

In various aspects, the plastic layer can have a thickness of from about 0.001 inches to about 0.003 inches, for example, about 0.001, 0.0015, 0.002, 0.0025, or 0.003 inches. In other aspects, the plastic layer can have a thickness of less than about 0.001 inches or greater than about 0.003 inches and the present disclosure is not intended to be limited to any particular thickness.

In another aspect, the plastic layer or at least a portion thereof comprises a material having at least a partial porosity, permeability, or a combination thereof to a matrix material. In yet another aspect, the plastic layer or at least a portion thereof is substantially permeable to the matrix material. In still another aspect, the plastic layer or at least a portion thereof is permeable to the matrix material.

In one aspect, the plastic layer or a portion thereof comprises a perforated material. In another aspect, the plastic layer or a portion thereof comprises an expanded material. In yet another aspect, the plastic layer or a portion thereof comprises a sintered material. In still other aspects, the plastic layer or a portion thereof can comprise any other physical form that can allow at least a portion of the matrix material to diffuse through, absorb, or otherwise physically interact therewith. In a specific aspect, the plastic layer comprises an expanded polyethylene material.

In various aspects, the plastic layer can have an open area ranging from about 40 to about 80 percent, for example, about 40, 45, 50, 55, 60, 65, 70, 75, or 80 percent. In other aspects, the plastic layer can have an open area of less than about 40 percent or greater than about 80 percent and the present disclosure is not intended to be limited to any particular open area.

The plastic layer of the present disclosure can have any electrical resistivity suitable for use in a lightning protection system, a fiber reinforced polymer composite, or a combination thereof. In one aspect, the plastic layer or at least a portion thereof has an electrical resistivity equal to or greater than the electrical resistivity of the matrix material. In another aspect, the plastic layer or at least a portion thereof has an electrical resistivity greater than the electrical resistivity of the matrix material.

In one aspect, the plastic layer or at least a portion thereof is dielectric or substantially dielectric.

Plastic materials, such as are suitable for use in the plastic layer of the present disclosure are commercially available and one of skill in the art could readily select an appropriate plastic material.

### Metal Foil Layer

The metal foil layer of the present disclosure can comprise any metal or metals suitable for use in a lightning protection system, a fiber reinforced polymer composite, or a combination thereof. In one aspect, the metal foil layer can comprise any transition metal or noble metal that can be at least partially volatilized upon a lightning strike.

In various aspects, the metal foil layer can comprise aluminum, copper, mixtures and/or alloys thereof, or a combination thereof In a specific aspect, the metal foil layer comprises aluminum. In another specific aspect, the metal foil layer comprises copper. In yet other aspects, the metal foil layer can comprise phosphor bronze, titanium, gold, mixtures and/or alloys thereof, in lieu of and/or in addition to those metals, alloys, and mixtures recited herein.

The dimensions of a metal foil layer can comprise any suitable dimensions for use with a lightning protection system, a fiber reinforced polymer composite, or a combination thereof. In one aspect, the length and width of a metal foil layer or a portion thereof can be selected so as to at least partially cover an exterior surface of a fiber reinforced polymer composite structure. In another aspect, the length and width of a metal foil layer or a portion thereof can be selected so as to be positioned within and near an exterior surface of a fiber reinforced polymer composite structure.

The thickness of a metal foil layer can vary depending upon, for example, the intended application, the specific structure onto or into which the metal foil is positioned, the amount of energy desired to be dispersed, or a combination thereof. In various aspects, the thickness of a metal foil layer can range from about 0.002 inches to about 0.005 inches, for example, about 0.002, 0.0025, 0.003, 0.0035, 0.004, 0.0045, or 0.005 inches. In other aspects, the thickness of a metal foil layer can be less than about 0.002 inches or greater than about 0.005 inches and the present disclosure is not intended to be limited to any particular metal foil thickness. In one aspect, the metal foil layer or at least a portion thereof has a thickness suitable for being at least partially volatilized upon an incident lightning strike.

In various aspects, the metal foil layer can comprise a solid metal foil, an expanded foil, a woven wire screen, an interwoven wire, or a combination thereof. In a specific aspect, the metal foil layer comprises a solid metal foil. In another specific aspect, the metal foil layer comprises an expanded foil. It should be understood that the physical form, for example, expanded foil, of a metal foil layer can vary and the present disclosure is not intended to be limited to any particular form of a metal foil layer.

Metals, such as those suitable for use in the metal foil of the present disclosure, are commercially available and one of skill in the art could readily select an appropriate metal for use with the various aspects of the present disclosure.

### Matrix Material

The matrix material of the present disclosure can be any matrix material suitable for use in a lightning protection system, a fiber reinforced polymer structure, or a combination thereof.

In one aspect, the matrix material of the present disclosure comprises a resin material. In another aspect, the matrix material of the present disclosure comprises a thermoplastic material. In yet another aspect, the matrix material is capable of at least partially permeating and/or diffusing into and/or through the plastic layer. In another aspect, the matrix material is capable of bonding and/or affixing the structure of the composite component, for example, the metal foil layer, the plastic layer, and optionally any other components that can be present.

In various aspects, the matrix material can comprise a plurality of materials in, for example, discrete layers. Such layers can comprise a surfacing material, carbon fiber, honeycomb structures of, for example, aluminum, other materials and combinations thereof.

Matrix materials, such as, for example, resin materials and thermoplastic materials are commercially available and one of skill in the art could readily select an appropriate matrix material for use with the various aspects of the present disclosure.

### Composite Structure

The composite structure of the present disclosure can comprise a graphite component, together with a metal foil layer, a plastic layer, and a matrix material. The specific composition, dimensions, and arrangement of any individual components of a composite structure can vary depending upon, for example, the intended application and specific desired properties thereof.

In one aspect, the composite structure comprises a graphite component that can act as a reinforcing member of the structure. In another aspect, such a graphite component can comprise an individual component, multiple discrete or connected components, and/or a complex structure. The specific design and configuration of a graphite component can vary depending upon the desired properties of the resulting composite structure.

In one aspect, the metal foil layer of the composite structure is positioned such that it is near or at an exterior surface of the composite structure. In another aspect, the metal foil layer and the graphite component are not in direct contact. In yet another aspect, direct contact between the metal foil layer and the graphite component is minimized or eliminated.

In one aspect, the expanded metal can be positioned such that, upon a lightning strike incident upon the expanded metal or the composite material onto or into which the expanded metal is positioned, the expanded metal or a portion thereof can vaporize, absorbing at least a portion of the energy of the incident lightning strike.

In various aspects, a lightning protection system and/or a composite structure comprising such a lightning protection system can comprise no or substantially no glass fiber layer or woven glass layer. In one aspect, substantially no glass fiber or woven glass layer is present. In another aspect, no glass fiber or woven glass layer is present.

One of the potential advantages to the various aspects of the present disclosure is that prior approaches failed to adequately understand the conductive pathways within a composite structure that can lead to electrochemical reactions and the subsequent breakdown, corrosion, and/or deterioration of components. While not wishing to be bound by theory, it is believed that the conductive pathway for electrochemical (e.g., galvanic) reactions in a traditional glass containing composite structure is the resin matrix material, and not the glass component. Thus, it can be possible, in various aspects, to achieve equivalent or greater insulating performance using materials having an electrical conductivity equal to or lesser than the resin matrix material.

Although several aspects of the present invention have been illustrated in the accompanying drawings and described in the detailed description, it should be understood that the invention is not limited to the aspects disclosed, but is capable of numerous rearrangements, modifications and substitutions without departing from the spirit of the invention as set forth and defined by the following claims.

### EXAMPLES

To further illustrate the principles of the present invention, the following examples are put forth so as to provide those of ordinary skill in the art with a complete disclosure and description of how the compositions, articles, devices, and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1

### Lightning Protection Structure

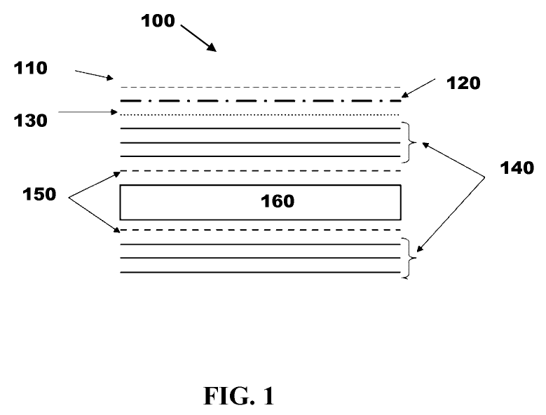

In a first example, an exemplary lightning protection structure 100 is illustrated in FIG. 1. The exemplary structure comprises a honeycomb core 160 that can comprise, for example, aluminum. Positioned in at least partial overlying registration and on opposing sides of the honeycomb core are one or more layers of a carbon material 140, optionally bonded to the honeycomb core with an adhesive 150. On the opposing side of at least one of the carbon material layers, additional layers of an isolation ply (plastic layer) 130, a metal foil lightning protection layer 120, and a surfacing layer 110 can be sequentially positioned in at least partial overlying registration.

Throughout this application, various publications are referenced. The disclosures of these publications in their entireties are hereby incorporated by reference into this application in order to more fully describe the compositions, articles, device, and methods described herein.

Various modifications and variations can be made to the compositions, articles, devices, and methods described herein. Other aspects of the compositions, articles, devices, and methods described herein will be apparent from consideration of the specification and practice of the compositions, articles, devices, and methods disclosed herein. It is intended that the specification and examples be considered as exemplary.

What is claimed is:

1. A lightning protection system comprising:
a. a plastic layer;
b. a metal foil layer positioned in at least partial overlying registration therewith, and
c. a matrix material in at least partial contact with both the plastic layer and the metal foil layer.

2. The lightning protection system of claim 1, wherein the metal foil layer comprises a solid foil, an expanded foil, a woven wire screen, an interwoven wire, or a combination thereof.

3. The lightning protection system of claim 1, wherein the metal foil layer comprises aluminum, copper, or a combination thereof.

4. The lightning protection system of claim 1, wherein the plastic layer comprises a polyolefin, a polyester, a fluoropolymer, a polyurethane, a polysulfone, or a combination thereof.

5. The lightning protection system of claim 1, wherein the plastic layer is dielectric or substantially dielectric.

6. The lightning protection system of claim 1, wherein the plastic layer is substantially permeable to the matrix material.

7. The lightning protection system of claim 1, wherein the plastic layer comprises an expanded material, a perforated material, or a combination thereof.

8. The lightning protection system of claim 1, wherein neither a glass fiber layer nor a woven glass layer is present.

9. The lightning protection system of claim 1, wherein the metal foil layer is capable of being at least partially vaporized when struck by lightning.

10. The lightning protection system of claim 1, wherein the plastic layer has an electrical conductivity less than or equal to the electrical conductivity of the matrix material.

11. A composite structure comprising a graphite component and the lightning protection system of claim 1, wherein the metal foil layer and the graphite component are not in direct contact.

12. The composite structure of claim 11, wherein the plastic layer prevents at least a portion of a galvanic reaction between the graphite component and the metal foil layer.

13. The composite structure of claim 11, wherein neither a glass fiber layer nor a woven glass layer is present.

14. The composite structure of claim 11, wherein the metal foil layer is capable of being at least partially vaporized when struck by lightning.
